(19) United States
(12) Patent Application Publication
(10) Pub. No.: US 2022/0366901 A1
(43) Pub. Date: Nov. 17, 2022

(54) Intelligent Interactive Voice Recognition System

(71) Applicant: Bank of America Corporation, Charlotte, NC (US)

(72) Inventors: Nandini Rathaur, Hyderabad (IN); Sneha Padiyar, Andherei, East Mumbai (IN); Sandeep Kumar Chauhan, Hyderabad (IN)

(21) Appl. No.: 17/318,463

(22) Filed: May 12, 2021

(51) Int. Cl. G10L 15/197; G10L 15/06; G10L 15/22; G10L 21/0232; G10L 15/18; G10L 25/78; G10L 15/20; G06F 16/245

(52) U.S. Cl. CPC G10L 15/197; G10L 15/063; G10L 15/22; G10L 21/0232; G10L 15/1815; G10L 25/78; G10L 15/20; G06F 16/245; G10L 2015/223; G10L 2015/225; G06N 20/00

(57) ABSTRACT

Systems for performing intelligent interactive voice recognition functions are provided. In some aspects, natural language data may be received from a plurality of users. The natural language data may be used to train a machine learning model. After training the machine learning model, additional or subsequent natural language input data may be received. The natural language data may include a user query, such as a request to obtain information from the system, to process a transaction, or the like. The natural language data may be processed to remove noise associated with the audio data. The data may then be further processed using the machine learning model to interpret the query of the user and generate an output. The output may be transmitted to the user and feedback data may be received from the user. The user-specific machine learning dataset may then be validated and/or updated based on the feedback data.

### BACKGROUND

Aspects of the disclosure relate to electrical computers, systems, and devices performing intelligent interactive voice recognition functions.

Interactive voice response (IVR) is used in various industries to provide efficient and effective customer service. However, for differently abled people, using IVR may be difficult or impossible. For instance, people having atypical speech patterns, may find it difficult to effectively use IVR. Accordingly, aspects described herein are related to an intelligent IVR system that uses machine learning to better serve people with atypical speech patterns in order to understand voice input, interpret the intent of the user, and the like.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with implementing and executing interactive voice recognition systems.

In some aspects, natural language data may be received from a plurality of users. For instance, over time, natural language and/or audio data may be received by the interactive voice recognition system. This data may include data from a plurality of different users. The natural language data may be used to train a machine learning model.

After training the machine learning model, additional or subsequent natural language input data may be received. The natural language data may include a user query, such as a request to obtain information from the system, to process a transaction, or the like. The natural language data may be processed to remove noise associated with the audio data. The data may then be further processed using the machine learning model to interpret the query of the user and generate an output. The output may be transmitted to the user and feedback data may be received from the user. The user-specific machine learning dataset may then be validated and/or updated based on the feedback data.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing intelligent interactive voice recognition functions in accordance with one or more aspects described herein;

FIGS. 2A-2H depict an illustrative event sequence for implementing intelligent interactive voice recognition functions in accordance with one or more aspects described herein;

FIG. 3 depicts an illustrative method for implementing intelligent interactive voice recognition functions according to one or more aspects described herein;

FIG. 4 illustrates another method for implementing intelligent interactive voice recognition functions according to one or more aspects described herein;

FIG. 5 illustrates one example environment in which various aspects of the disclosure may be implemented in accordance with one or more aspects described herein; and

FIG. 6 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional interactive voice recognition systems may struggle to accurately interpret speech from users having atypical speech patterns. Accordingly, aspects described herein use machine learning to analyze natural language data received from users to more accurately interpret natural language input, generate outputs, and the like.

These and various other arrangements will be discussed more fully below.

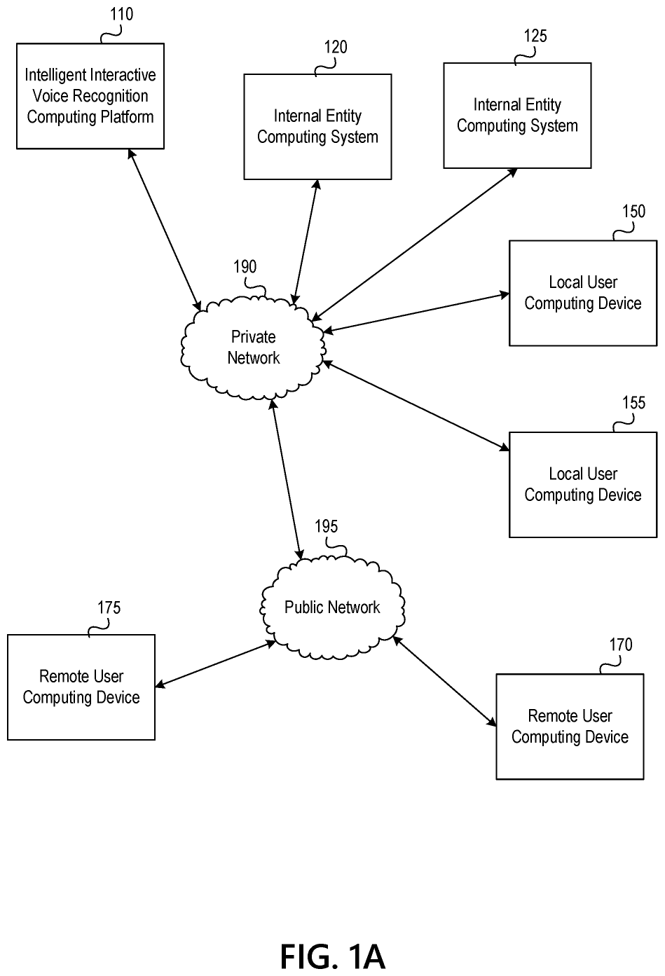

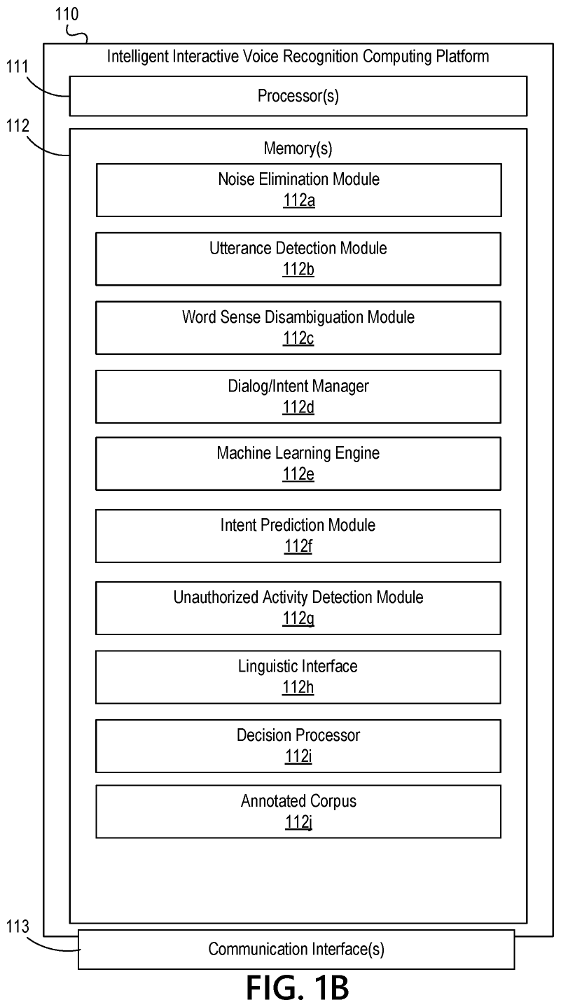

FIGS. 1A-1B depict an illustrative computing environment for implementing and using intelligent interactive voice recognition functions in accordance with one or more aspects described herein. Referring to FIG. 1A, computing environment 100 may include one or more computing devices and/or other computing systems. For example, computing environment 100 may include intelligent interactive voice recognition computing platform 110, internal entity computing system 120, internal entity computing system 125, a first local user computing device 150, a second local user computing device 155, a first remote user computing device 170, and a second remote user computing device 175. Although two internal entity computing systems 120, 125, two local user computing devices 150, 155, and two remote user computing devices 170, 175 are shown, additional devices or systems may be used without departing from the invention.

Intelligent interactive voice recognition computing platform 110 may be configured to provide intelligent, dynamic voice recognition processing for users speaking a variety of languages, dialects, or the like. Further, the intelligent interactive voice recognition computing platform 110 may provide voice recognition and processing for users having an atypical speech pattern (e.g., a user having a speech impediment, or the like). In some examples, natural language or voice data may be received by the intelligent interactive voice recognition computing platform 110. For instance, a user may call in to an enterprise organization service center and may provide natural language or voice input via an interactive voice recognition system executing on one or more computing devices or systems of the enterprise organization, such as internal entity computing system 120 and/or internal entity computing system 125.

The natural language or voice data may be received and processed by the intelligent interactive voice recognition computing platform 110. For instance, the voice data may be processed via a series of modules that perform various noise reduction processes, word disambiguation processes, contextual understanding processes, and the like. In some examples, machine learning may be used to interpret voice data, evaluate context, determine a relevant meaning, and the like.

In some examples, multiple machine learning models and/or datasets may be used to process the natural language or voice data. For instance, machine learning models and/or datasets may be built, trained, and executed to analyze natural language or voice data from a particular customer or user (e.g., from data received from a plurality of customers or users). For instance, a machine learning model may analyze data from each user and build/train one or more machine learning datasets for the particular user. As the user makes subsequent calls to the system and provides additional natural language or voice data, the natural language or voice data may be analyzed using the machine learning dataset associated with that user. This may improve efficiency and accuracy in evaluating that particular user's voice data. The subsequent data may be used to update and/or validate the user-specific machine learning datasets to continuously improve accuracy.

Additionally or alternatively, the intelligent interactive voice recognition computing platform 110 may use one or more machine learning models and/or datasets to generally evaluate and analyze natural language or voice data received (e.g., from any customer). Accordingly, one or more machine learning models may be used to generate, train, and/or execute one or more machine learning datasets for use with any customer or user (e.g., non-user-specific machine learning datasets). Accordingly, historical voice data, event processing data, and the like, captured from a plurality of users may be used to build and train a machine learning model in order to generate one or more machine learning datasets that may be used to evaluate voice data received from any user, even first-time users of the system. The data that is subsequently received may be used to update and/or validate the one or more machine learning datasets in order to continuously improve accuracy and efficiency.

After processing the natural language or voice data, intelligent interactive voice recognition computing platform 110 may then generate one or more decisions or outputs. For instance, the intelligent interactive voice recognition computing platform 110 may generate an output including an interpretation of the natural language or voice data received (e.g., a query identified from the voice data, a command identified from the voice data, or the like) and may determine a response. For instance, a response may be a follow-up question presented to the user, presentation of data retrieved based on the user request, or the like. The user may then provide natural language or voice input asking for additional information, providing another request, indicating that the information provided was not helpful, or the like. This data may be used to update and/or validate one or more machine learning datasets to improve accuracy for subsequent voice data analysis processes.

Internal entity computing system 120 and/or internal entity computing system 125 include one or more computing devices, systems, or the like, internal to an enterprise organization implementing the intelligent interactive voice recognition computing platform 110. For instance, internal entity computing system 120 and/or internal entity computing system 125 may execute or host one or more systems, applications, or the like, to perform one or more functions for the enterprise organization. In some examples, one or more of internal entity computing system 120 and/or internal entity computing system 125 may include customer service applications or systems to execute an interactive voice recognition system to facilitate customer service requests from users. Additionally or alternatively, one or more of internal entity computing system 120 and/or internal entity computing system 125 may include one or more systems or applications for storing user data (e.g., user identifying data, user account data, or the like), processing one or more transactions (e.g., account control processes, account ledger updating processing, and the like), or the like.

Local user computing device 150 and/or local user computing device 155 may include one or more computing devices associated with the enterprise organization. Local user computing device 150 and/or local user computing device 155 may be operated by a user associated within the enterprise organization. For instance, local user computing device 150 and/or local user computing device 155 may be operated by an employee of enterprise organization and may be used to modify aspect of the intelligent interactive voice recognition computing platform 110, assist customers or users if the intelligent interactive voice recognition computing platform 110 does not provide sufficient output for the user, or the like.

Remote user computing device 170 and/or remote user computing device 175 may be one or more computing devices associated with users outside of or external to the enterprise organization. For instance, remote user computing device 170 and/or remote user computing device 175 may be computing devices, such as smartphones, tablet computers, laptop computers, or the like, associated with one or more customers of the enterprise organization. In some examples, remote user computing device 170 and/or remote user computing device 175 may be used to communicate with the intelligent interactive voice recognition computing platform 110 (e.g., may receive and transmit voice data, may receive and transmit response data, or the like).

Computing environment 100 also may include one or more computing platforms. For example, and as noted above, computing environment 100 may include intelligent interactive voice recognition computing platform 110. As illustrated in greater detail below, intelligent interactive voice recognition computing platform 110 may include one or more computing devices configured to perform one or more of the functions described herein. For example, intelligent interactive voice recognition computing platform 110 may include one or more computers (e.g., laptop computers, desktop computers, servers, server blades, or the like).

As mentioned above, computing environment 100 also may include one or more networks, which may interconnect one or more of intelligent interactive voice recognition computing platform 110, internal entity computing system 120, internal entity computing system 125, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, intelligent interactive voice recognition computing platform 110, internal entity computing system 120, internal entity computing system 125, local user computing device 150, and local user computing device 155, may be associated with an enterprise organization (e.g., a financial institution), and private network 190 may be associated with and/or operated by the organization, and may include one or more networks (e.g., LANs, WANs, virtual private networks (VPNs), or the like) that interconnect intelligent interactive voice recognition computing platform 110, internal entity computing system 120, internal entity computing system 125, local user computing device 150, local user computing device 155, and one or more other computing devices and/or computer systems that are used by, operated by, and/or otherwise associated with the organization. Public network 195 may connect private network 190 and/or one or more computing devices connected thereto (e.g., intelligent interactive voice recognition computing platform 110, internal entity computing system 120, internal entity computing system 125, local user computing device 150, local user computing device 155) with one or more networks and/or computing devices that are not associated with the organization. For example, remote user computing device 170 and/or remote user computing device 175, might not be associated with an organization that operates private network 190 (e.g., because remote user computing device 170 and/or remote user computing device 175 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect remote user computing device 170 and/or remote user computing device 175 to private network 190 and/or one or more computing devices connected thereto (e.g., intelligent interactive voice recognition computing platform 110, internal entity computing system 120, internal entity computing system 125, local user computing device 150, local user computing device 155).

Referring to FIG. 1B, intelligent interactive voice recognition computing platform 110 may include one or more processors 111, memory 112, and communication interface 113. A data bus may interconnect processor(s) 111, memory 112, and communication interface 113. Communication interface 113 may be a network interface configured to support communication between intelligent interactive voice recognition computing platform 110 and one or more networks (e.g., private network 190, public network 195, or the like). Memory 112 may include one or more program modules having instructions that when executed by processor(s) 111 cause intelligent interactive voice recognition computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of intelligent interactive voice recognition computing platform 110 and/or by different computing devices that may form and/or otherwise make up intelligent interactive voice recognition computing platform 110.

For example, memory 112 may have, store and/or include a noise elimination module 112a. Noise elimination module 112a may store instructions and/or data that may cause or enable the intelligent interactive voice recognition computing platform 110 to execute one or more noise reduction processes on the natural language or voice data received. For instance, one or more filtering or other noise reduction processes may be executed to isolate the relevant voice data. For instance, noise cancellation and/or active noise reduction may be used to reduce or remove unwanted sound from the natural language or voice data.

Memory 112 may further have, store and/or include an utterance detector 112b. Utterance detector 112b may store instructions and/or data that may cause or enable the intelligent interactive voice recognition computing platform 110 to aid in listening and detecting relevant audio data from an active user. For instance, in arrangements in which a user is in a crowded area the interactive voice recognition system (e.g., the system to which the user is connected and providing voice data) may receive audio data from multiple speakers, multi-media audio (e.g., from television, radio, or the like). The intended speech or voice data (device-directed) may be detected while unintended speech or voice data (e.g., non-device-directed) may be discarded.

Memory 112 may further have, store and/or include word sense disambiguation module 112c. Word sense disambiguation module 112c may store instructions and/or data that may cause or enable the intelligent interactive voice recognition computing platform 110 to disambiguate words in the voice data to identify a proper meaning associated with the words. For instance, the word sense disambiguation module 112c may include a query analyzer which may analyze the voice input or data based on recent history of calls and/or transactions, as well as a current status of the customer. The query analyzer may retrieve data about a user (e.g., based on user information provided via the voice session, data retrieved from one or more internal entity computing systems, such as internal entity computing system 120, internal entity computing system 125, or the like, or the like, and may use that data as context in analyzing the received voice data.

Word sense disambiguation module 112c may further include a context detector which may be sense-annotated thereby inducing the correct sense of an individual spoken word in a particular context. This may aid in removing ambiguity that may arise due to different meanings of words in different contexts. For instance, the context detector may help to identify the correct sense of a word that does not necessarily convey a complete meaning on its own. In some examples, the context detector may identify or detect emotion associated with the data received (e.g., urgency, panic, or the like), which may then be used to determine the sense of the words. The context detector may allow speech impaired customers to have a more natural interaction with the interactive voice recognition system because the interactive voice recognition system may immediately reenter a listening state after a first query (e.g., without wake-word repetition) and accept or reject a potential follow up as device directed.

Memory 112 may further have, store and/or include a dialog/intent manager 112d. Dialog/intent manager 112d may store instructions and/or data that may cause or enable the intelligent interactive voice recognition computing platform 110 to calculate or determine intent level statistics including confusion matrix, F1 score, precision and recall. The dialog/intent manager 112d may aid in understanding an intent of the customer and determine whether it is a complaint, concern or request. This may aid in clustering analysis of previous or historical data to build intents of customers and improve usability for current and future needs.

Memory 112 may further have, store and/or include a machine learning engine 112e. Machine learning engine 112e may store instructions and/or data that may cause or enable intelligent interactive voice recognition computing platform 110 to train a machine learning model and build and validate one or more machine learning datasets (e.g., user-specific datasets, general datasets), analyze voice queries, identify a user (if user-specific datasets are available), evaluate intent of words received, match word meanings to context, understand, interpret or predict context, and the like. For instance, machine learning datasets may be generated for particular users (e.g., as a user accesses the intelligent interactive voice recognition computing platform 110, datasets may be generated and those datasets may be updated and/or validated upon receiving subsequent access from the user), or generally created for all users (e.g., machine learning datasets may be generated that may be used to analyze any or all users accessing the intelligent interactive voice recognition computing platform 110, even first-time users). The machine learning models may be trained on historical data (e.g., to generated machine learning datasets) and updated and/or validated upon receiving further voice data and feedback from one or more users, thereby constantly refining and improving accuracy of the analysis (e.g., for future users).

Various machine learning algorithms may be used (e.g., by the machine learning engine 112e) without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention. In some examples, the machine learning engine 112e may analyze data to identify patterns of activity, sequences of activity, and the like, to generate one or more machine learning datasets.

In some examples, machine learning may be used to provide contextual understanding. For instance, machine learning may be used to understand or recognize references from a previous utterance. For instance, if the user asks a follow up question, the contextual understanding module may recognize that the second utterance is related to the first utterance and process it in accordance with the previous utterance.

Memory 112 may further have, store and/or include intent prediction module 112f. Intent prediction module 112f may use machine learning classifiers to predict the best possible intent of the voice input. The intent prediction module 112f may turn audio data into text data and may execute one or more algorithms that transform the text into words labeling them based on position and function in a sentence.

Memory 112 may further have, store and/or include unauthorized activity detection module 112g. Unauthorized activity detection module may have or store instructions that may cause or enable the intelligent interactive voice recognition computing platform 110 to add a layer of voice authentication onto other authentication systems and methods used. For instance, a user may be requested to provide authenticating information upon contacting the computing platform 110. Some examples of authenticating information may include password, personal identification number, or the like. The authenticating data may be compared to pre-stored data and, if a match exists, the user may be authenticated. In some examples, a voice print of the audio data may be compared to previous captured voice print data for the user. In another example, unauthorized activity detection module 112g may evaluate the natural language data received for unusual amounts of noise, changes in pitch of the user, use of mimicry, or the like, that may indicate unauthorized use. These features may provide another layer of authentication and security.

Memory 112 may further have, store and/or include linguistic interface 112h. Linguistic interface may include instructions and/or data that may cause or enable the intelligent interactive voice recognition computing platform 110 to identify or select a language, dialect, or the like, associated with the user audio data and may instruct the intelligent interactive voice recognition computing platform 110 to analyze the data based on the identified language, dialect, or the like. In some examples, the linguistic interface 112h may provide user selectable options such that a user may select a desired language, dialect, or the like. Additionally or alternatively, the linguistic interface 112h may automatically select a language, dialect, or the like, based on audio data received from the user.

Memory 112 may further have, store and/or include decision processor 112i. Decision processor 112i may store instructions and/or data that may cause or enable the intelligent interactive voice recognition computing platform 110 to receive outputs from previous processes (e.g., contextual understanding, speech processor output, customer data, and the like) and generate a response or output for the user. In some examples, the response or output may be an answer to a user question. Additionally or alternatively, the response or output may include execution of steps in a decision tree in which the user may be prompted with one or more options that may lead to additional options to provide the requested service to the user, or the like. The decision processor may, in some examples, rely on a service registry that may include services, decision trees, and the like, associated with the entity implementing the system. For instance, if the enterprise organization implementing the system is a financial institution, the service registry may include banking knowledge, synonyms, frequent issues, or the like, associated with the banking or financial industry.

The decision processor may also include a feedback module. The feedback module may receive response and/or feedback data from a user and update and/or validate one or more analysis processes, machine learning models, or the like. Accordingly, the system may be continuously refining analysis to ensure improved outputs.

Memory 112 may further have, store and/or include an annotated corpus 112j. Annotated corpus 112j may store data that may aid intelligent interactive voice recognition system in understanding a wide variety of dialects and speech. For instance, natural language processing may be used to annotate meaningful words captured from a user sentence or utterance to make it usable for machine learning to understand a term or string of words. The annotated corpus may be used with one or more word sense disambiguation processes described herein that may enable the processor to deduce the correct sense of the word being spoken.

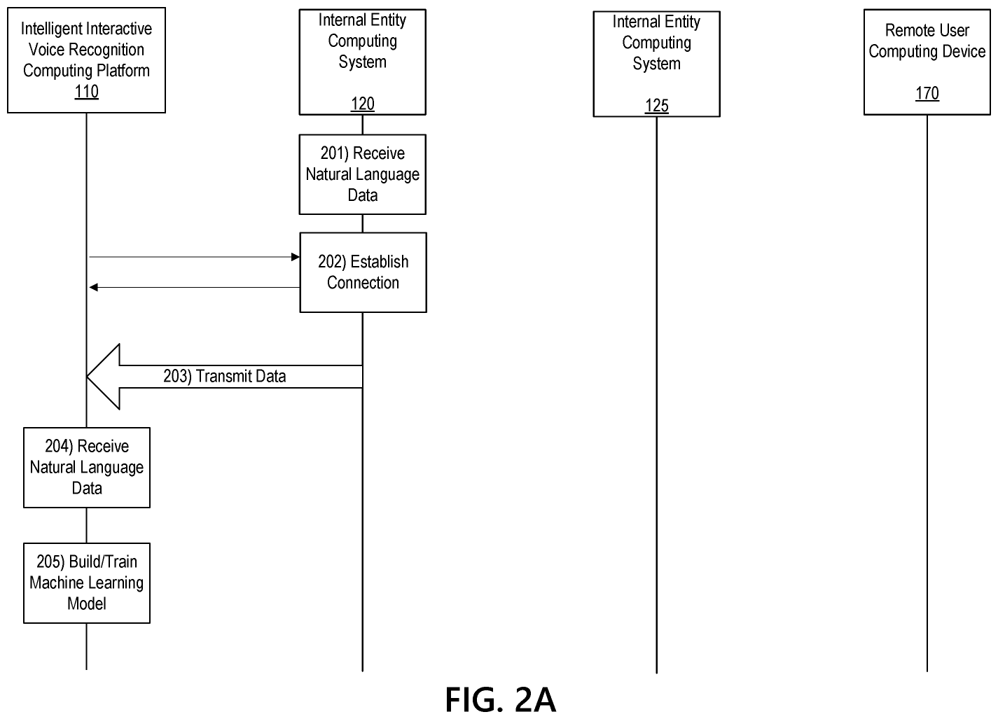

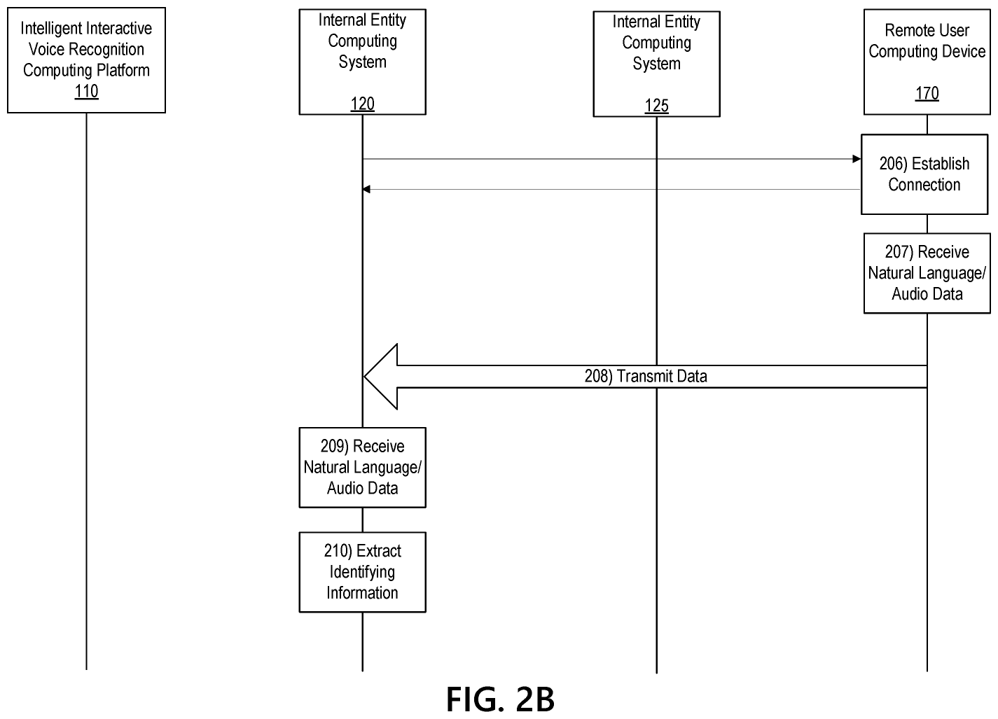

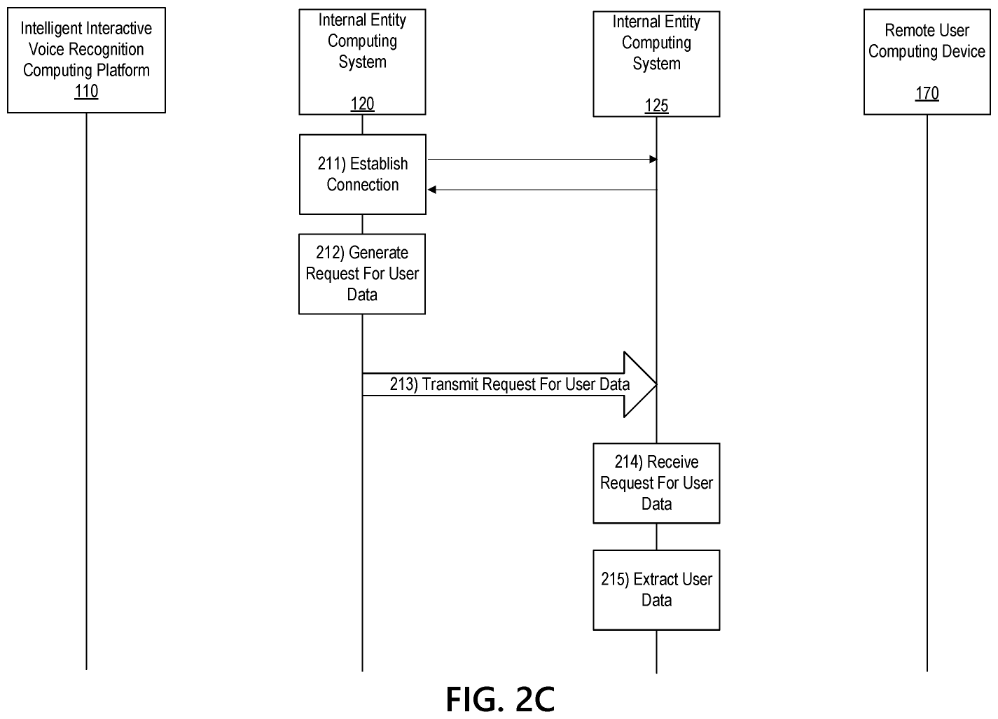

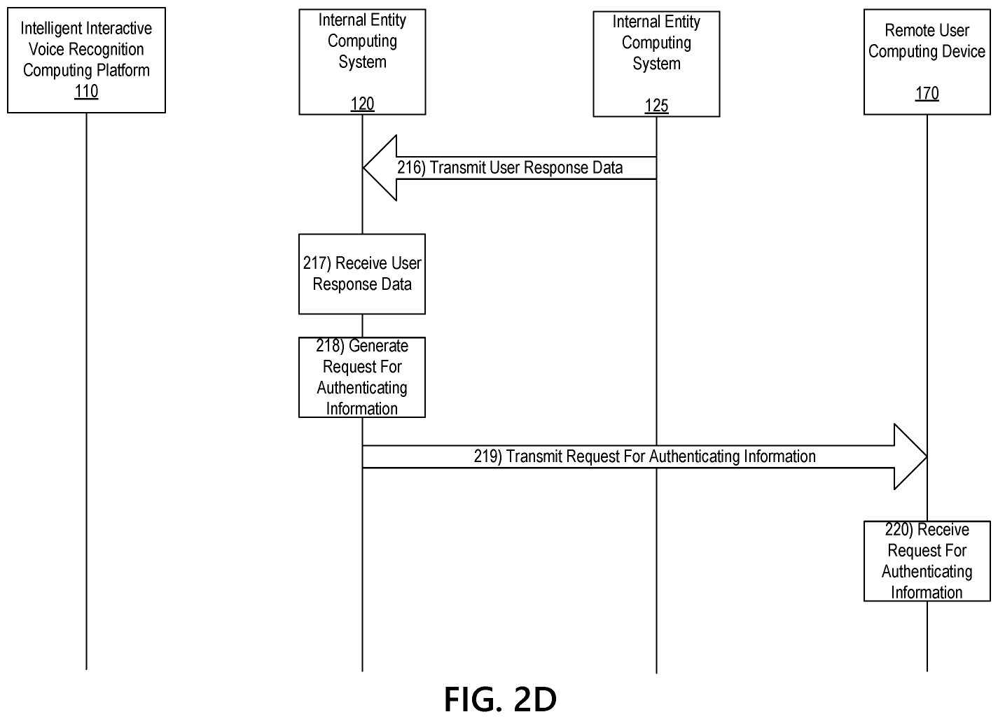

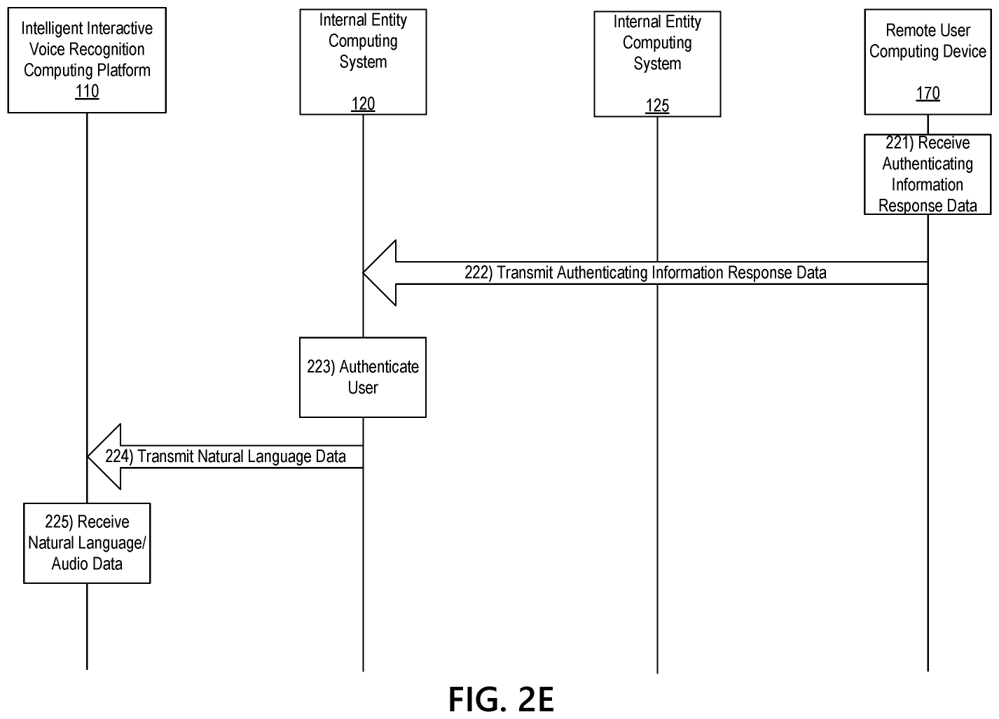

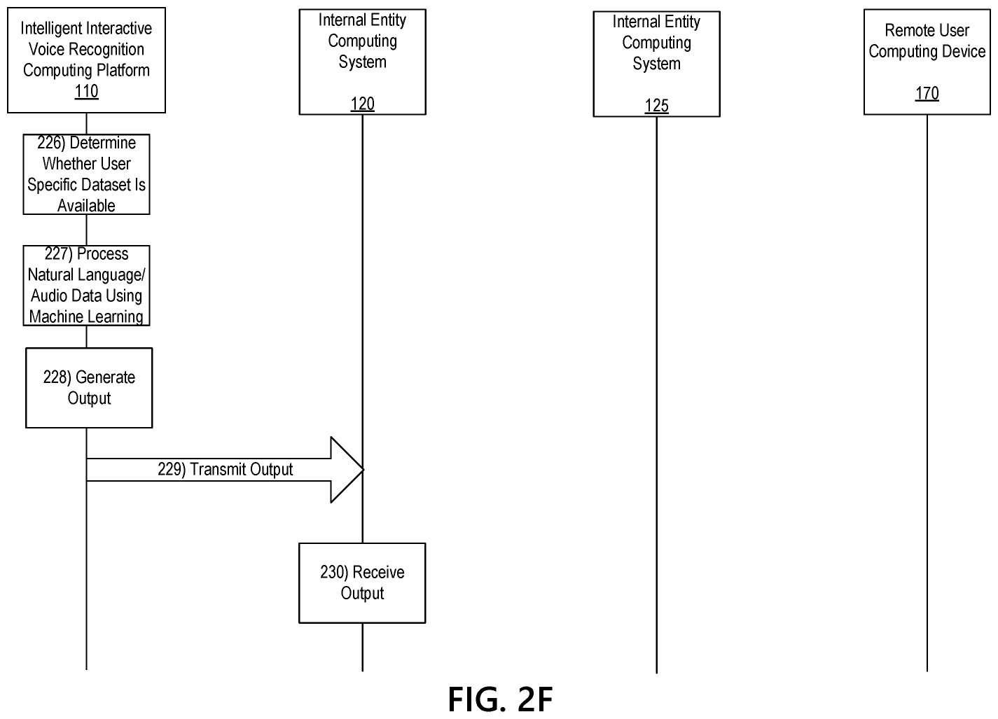

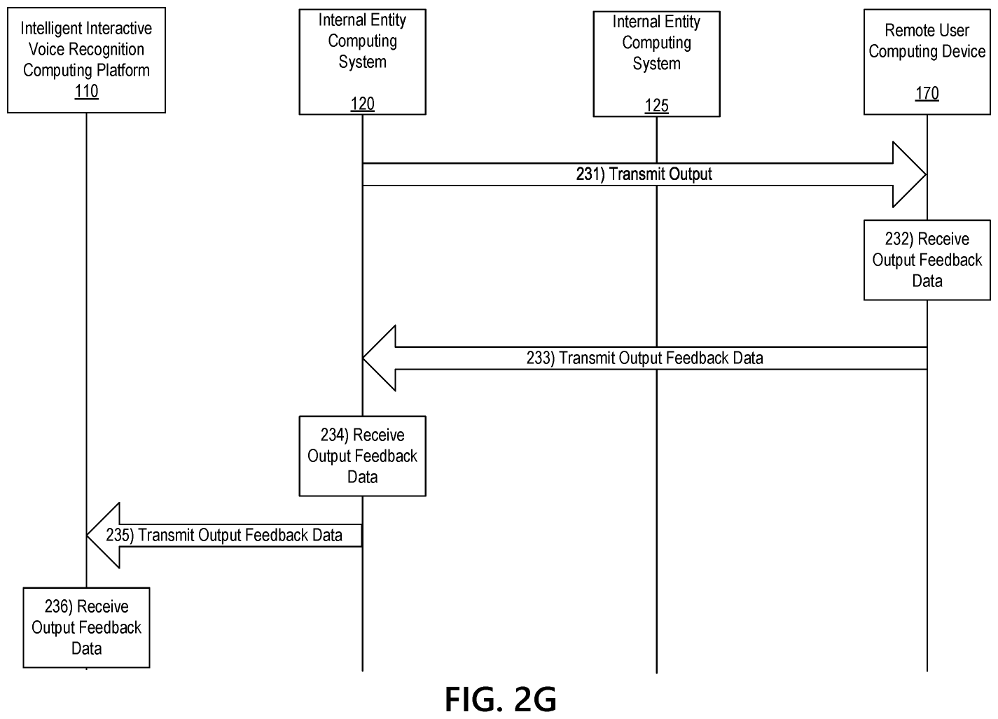

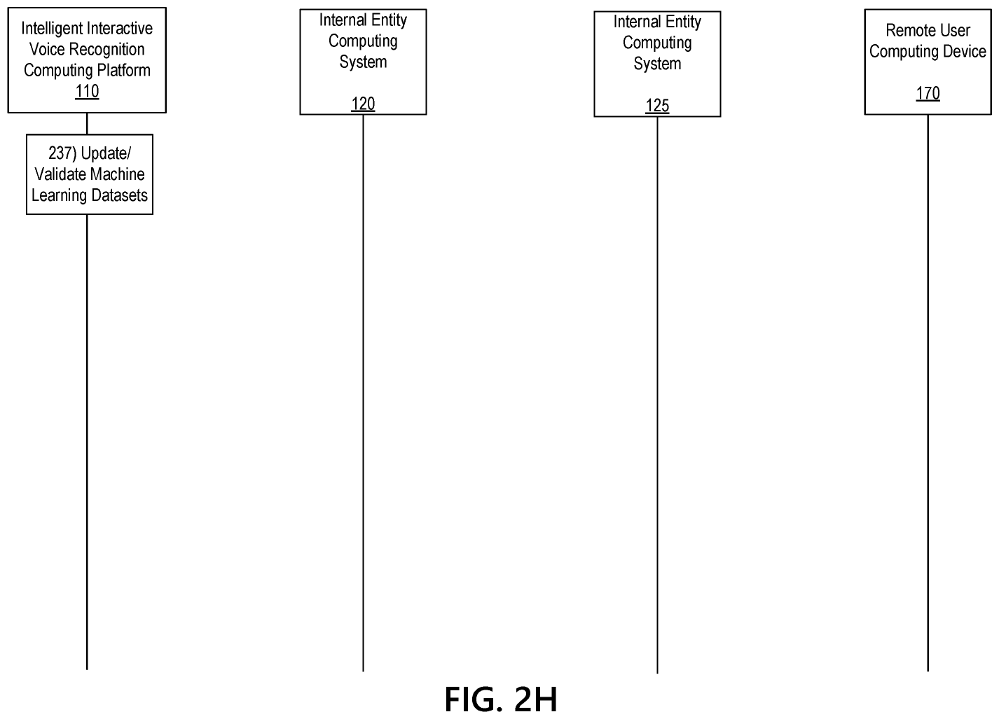

FIGS. 2A-2H depict one example illustrative event sequence for implementing and using intelligent interactive voice recognition functions in accordance with one or more aspects described herein. The events shown in the illustrative event sequence are merely one example sequence and additional events may be added, or events may be omitted, without departing from the invention. Further, one or more processes discussed with respect to FIGS. 2A-2H may be performed in real-time or near real-time.

Referring to FIG. 2A, at step 201, a system, such as internal entity computing system 120, may receive natural language or voice data. In some examples, internal entity computing system 120 may be or include one or more computing devices or systems supporting a customer service center and executing an interactive voice recognition system to provide customer service, response to use queries, generate customer outputs, and the like. In some examples, the data received may include historical data captured for a plurality of users over a time period. Additionally or alternatively, user natural language data may be continuously captured.

At step 202, a connection may be established between the internal entity computing system 120 and the intelligent interactive voice recognition computing platform 110. For instance, a first wireless connection may be established between the internal entity computing system 120 and intelligent interactive voice recognition computing platform 110. Upon establishing the first wireless connection, a communication session may be initiated between intelligent interactive voice recognition computing platform 110 and internal entity computing system 120.

At step 203, the natural language data may be transmitted from the internal entity computing system 120 to the intelligent interactive voice recognition computing platform 110. For instance, the data may be transmitted during the communication session initiated upon establishing the first wireless connection.

At step 204, the natural language data may be received. At step 205, one or more machine learning models may be built or trained using the received natural language data. For instance, one or more user-specific or general machine learning datasets may be generated based on the processed natural language data used to build or train the machine learning models. Accordingly, in training the models, user identifying data may be used to generate user-specific machine learning datasets, while data from all or a variety of users may be used to train the general machine learning datasets.

With reference to FIG. 2B, at step 206, a connection may be established between the remote user computing device 170 and the internal entity computing system 120. For instance, a user may call into an interactive voice recognition system hosted by internal entity computing system 120 and a second wireless connection may be established between the internal entity computing system 120 and remote user computing device 170. Upon establishing the second wireless connection, a communication session may be initiated between internal entity computing system 120 and the remote user computing device 170.

At step 207, remote user computing device 170 may receive natural language/audio data (e.g., data received subsequent to the training data received in step 201). For instance, a user may provide a natural language query to the remote user computing device 170. The query may include a request for customer service, a request for a transaction (e.g., transfer funds), a request for information (e.g., balance request), or the like.

At step 208, the natural language/audio data may be transmitted from the remote user computing device 170 to the internal entity computing system 120. For instance, the natural language/audio data may be transmitted during the communication session initiated upon establishing the second wireless connection.

At step 209, the natural language/audio data may be received by internal entity computing system 120.

At step 210, identifying information may be extracted from the natural language/audio data. For instance, data associated with a user or device (e.g., remote user computing device 170) from which the natural language/audio data was received may be extracted from the natural language/audio data.

Based on the extracted identifying information, user data may be retrieved. For instance, with reference to FIG. 2C, at step 211, a connection may be established between the internal entity computing system 120 and internal entity computing system 125. For instance, a third wireless connection may be established between the internal entity computing system 120 and internal entity computing system 125. Upon establishing the third wireless connection, a communication session may be initiated between internal entity computing system 120 and the internal entity computing system 125.

At step 212, a request for user data may be generated. For instance, a request for user account data, authentication data, and the like, may be generated. The request for user data may be generated based on the extracted identifying information.

At step 213, the request for user data may be transmitted from the internal entity computing system 120 to the internal entity computing system 125. For instance, the request for user data may be transmitted during the communication session initiated upon establishing the third wireless connection.

At step 214, the request for user data may be received and, at step 215, the requested user data may be extracted or retrieved from one or more databases storing user data, account data, and the like.

With reference to FIG. 2D, at step 216, the retrieved or extracted data may be used to generate user response data that may be transmitted from the internal entity computing system 125 to internal entity computing system 120.

At step 217, the user response data may be received by the internal entity computing system 120.

At step 218, the internal entity computing system 120 may generate a request for user authentication data. For instance, in order to ensure the user is authorized to access data, the interactive voice recognition system hosted by internal entity computing system 120 may request authentication data from the user. The authentication data may include a username and password, personal identification number, response to challenge question, or the like.

At step 219, the request for authentication information may be transmitted from internal entity computing system 120 to the remote user computing device 170. For instance, the interactive voice recognition system hosted by internal entity computing system 120 may request or present a request for the authentication data.

At step 220, the request for authenticating information may be received by the remote user computing device 170.

With reference to FIG. 2E, at step 221, authenticating information response data may be received by remote user computing device 170. For instance, a user may provide natural language or audio data including a response to the request for authenticating information. The natural language and/or audio data may include a username and password, personal identification number, response to challenge question, or the like.

At step 222, the authenticating information response data may be transmitted from the remote user computing device 170 to the internal entity computing system 120.

At step 223, the user may be authenticated. For instance, the authenticating information response data may be compared to pre-stored authentication data (e.g., retrieved as user data from internal entity computing system 125) to determine whether the data matches. If so, the user may be authenticated. If not, additional authenticating information may be requested and/or the query from the user may be denied.

At step 224, based on the user being authenticated, the natural language/audio data including the query from the user may be transmitted to the intelligent interactive voice recognition computing platform 110. In some examples, transmitting the natural language/audio data may include transmitting an indication that the user was authenticating, transmitting user identifying information, account information or other user information, and the like. At step 225, the natural language/audio data may be received by the intelligent interactive voice recognition computing platform 110.

With reference to FIG. 2F, at step 226, the system may evaluate the natural language/audio data, as well as user data identifying the user (e.g., from authentication data, user data, or the like), to determine whether one or more user-specific machine learning datasets are available for the user. If so, the machine learning dataset(s) associated with the user may be used to process the data. If not, general machine learning dataset(s) may be used to process the data. Accordingly, one or more machine learning datasets may be selected to process the data based on the user information.

At step 227, the natural language/audio data may be processed using the selected one or more machine learning datasets. For instance, the natural language/audio data may be analyzed to determine an output for the user. As discussed herein, analyzing the natural language/audio data may include performing one or more of the processes associated with the intelligent interactive voice recognition computing platform 110, as described in FIG. 1B. For instance, a noise eliminator may be used to filter the audio data and remove noise. Further, an utterance analysis may be performed to identify words that might not convey a particular or complete meaning. These terms may be further analyzed to identify a context associate with the words to accurately provide an output for the user.

Further, one or more word disambiguation processes may be performed by the intelligent interactive voice recognition computing platform 110. For instance, words may be disambiguated to enable proper sense of the spoken word received. In some examples, an annotated corpus may aid in annotating words for use in machine learning analysis. For instance, a machine classifier may be associated with a word based on comparison to annotated terms in the corpus to enable more accurate machine learning analysis.

As discussed herein, a dialog/intent manager may be used to provide a clustering analysis. For instance, user-specific machine learning may be used to perform the analysis if available. Additionally or alternatively, general machine learning (e.g., based on a plurality of user data) may be used.

Machine learning (e.g. user-specific or general) may be used to determine a relevant meaning for each word received. For instance, the context of each work may be determined and the relevant meaning may be identified. In some examples, users having various different speech patters (e.g., different dialects, speech impediments, or the like) may rely on the system for customer service. The machine learning aspects provided herein (e.g., both user-specific and general) may enable more accurate interpretation of natural language received from users having various speech patterns by performing this multi-step analysis and using vast amounts of historical data to generate machine learning datasets. In some examples, this relevant meaning may then be used to interpret subsequent natural language received from the user (e.g., follow-up instructions or questions, or the like).

In some examples, the processing at step 227 may further include intent prediction and voice coding. For instance, machine learning may be used to predict the most likely meaning of a word or words.

In some arrangements, the processing at step 227 may further include an unauthorize activity detection process. For instance, voice data from the user may be used to further authenticate or ensure authenticity of the user (e.g., matching voice print or pattern to pre-stored voice print or pattern). Further, the processing may include a linguistic interface to aid in identifying a language, dialect, or the like. In some examples, the linguistic interface may permit a user to select a language or dialect. Additionally or alternatively, the linguistic interface may automatically identify the language or dialect spoken by the user.

This information may then be used by, for instance, a decision processor, to generate an output for the user. For instance, at step 228, an output may be generated. The output may be based on the processing performed at step 227, as well as additional data such as user data, account data, or the like. The output may include a response to the query received with the natural language/audio data. For instance, if a user query includes a request for a balance of a checking account, the system may retrieve the balance data (e.g., from internal entity computing system 125) and provide the balance information as an output. Additionally or alternatively, the output may include a request for additional information from a user. For instance, if the user query includes an indication that they are having an issue with a system of the enterprise organization (e.g., an online banking system, mobile application, or the like), the output may include a request for additional information about the nature of the issue. Various other outputs may be generated without departing from the invention.

At step 229, the output may be transmitted from the intelligent interactive voice recognition computing platform 110 to the internal entity computing system 120. The internal entity computing system 120 may receive the output at step 230. In some examples, these steps may be omitted and the output may be transmitted directly from the intelligent interactive voice recognition computing platform 110 to the remote user computing device 170.

With reference to FIG. 2G, at step 231, the output may be transmitted to the remote user computing device 170.

At step 232, output feedback data may be received by the remote user computing device 170. For instance, the user may provide natural language input via the remote user computing device 170 including feedback responsive to the output. For instance, if the output requests additional information (e.g., type of issue, account from which balance should be transferred, account for balance request, or the like), the user may provide natural language via the remote user computing device 170 including output feedback response data.

At step 233, the output feedback data may be transmitted from the remote user computing device to the internal entity computing system 120. At step 234, the output feedback data may be received by the internal entity computing system 120. In some examples, steps 233 and 234 may be omitted and the output feedback data may be transmitted directly from the remote user computing device 170 to the intelligent interactive voice recognition computing platform 110.

At step 235, the output feedback data may be transmitted from the internal entity computing system 120 to the intelligent interactive voice recognition computing platform 110.

At step 236, the intelligent interactive voice recognition computing platform 110 may receive the output feedback data.

With reference to FIG. 2H, at step 237, one or more machine learning models or datasets may be updated and/or validated based on the output feedback data. For instance, the machine learning datasets may be updated and/or validated based on the output feedback data such that subsequent natural language queries may be analyzed with the updated datasets to improve accuracy, efficiency, and the like.

Although FIGS. 2A-2H describe different systems, devices, and the like, one or more systems, devices, or the like described with respect to FIGS. 2A-2H may be part of a single system or device. For instance, intelligent interactive voice recognition computing platform 110 may be part of a same device or system as internal entity computing system 120 (e.g., the interactive voice recognition system), internal entity computing system 125 (e.g., one or more internal systems storing user data), or the like.

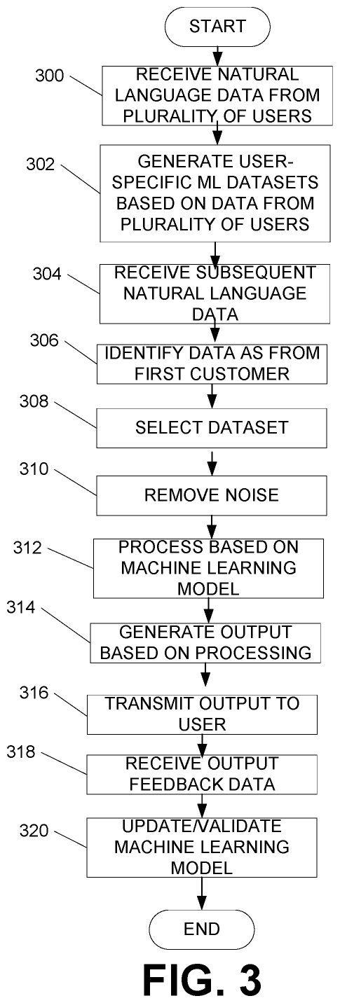

FIG. 3 is a flow chart illustrating one example method of implementing intelligent interactive voice recognition functions according to one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, natural language input may be received from a plurality of users or customers. In some examples, the plurality of users or customers may be a customer of an enterprise organization implementing the intelligent interactive voice recognition computing platform 110. In some examples, the natural language input may be received over a period of time and may include historical data. In some examples, the natural language input may include data associated with the each and identifying each user such that data associated with particular users may be extracted.

At step 302, one or more machine learning models may be built and/or trained based on the natural language data received from the plurality of users or customers. For instance, one or more user-specific machine learning datasets may be generated associated with one or more users or customers of the plurality of users or customers. This may provide improved understanding of each user during, for instance, subsequent interactions with the intelligent interactive voice recognition computing platform 110, particularly for speakers having atypical speech patterns that might be inaccurately interpreted using conventional interactive voice recognition systems. In some examples, one or more machine learning classifiers may be used to classify words, intent, or the like, of the user.

At step 304, subsequent natural language input data may be received from a user or customer. For instance, a first user or customer may contact the intelligent interactive voice recognition computing platform 110 (e.g., via internal entity computing system 120 or voice recognition system hosted thereon), after one or more previous interactions with the voice recognition system (e.g., previous interactions in which user data was captured to generate user-specific machine learning datasets). In some examples, the subsequent natural language input data may include a query from the first customer or user.

At step 306, based on the subsequent natural language input data received at step 304, the customer providing the natural language input at step 304 may be identified and/or recognized as the first user or customer. For instance, the customer may provide identifying information that may be used to identify the customer as the first user or customer. Additionally or alternatively, speech pattern data or other data provided by the user may be used to identify the customer as the first user or customer. In some examples, the query received from the user may be analyzed to identify the user. Based on the identification of the first customer, one or more user-specific machine learning datasets associated with the first user or customer may be identified to process the natural language input data received from the first customer at step 308.

In some examples, identifying the customer as the first customer may include retrieving data associated with the first customer. For instance, user data, user account data, user authentication data, and the like, may be retrieved and used to authenticate the user, generate outputs, and the like.

In some examples, in accessing the system, the user or customer may provide identifying and/or authenticating information to the system. For instance, the user may be authenticated by providing authentication response data that is compared to pre-stored data, as described herein.

At step 310, one or more noise reduction processes may be performed on the natural language input data received. For instance, one or more filtering or other noise reduction processes may be executed to isolate the relevant voice data.

At step 312, the isolated (e.g., noise removed) voice recognition data may be processed using the one or more user-specific machine learning datasets and/or one or more processes described herein. For instance, the various processes described herein may be executed (e.g., using machine learning associated with the first customer) to determine an intent of the customer, identify the request, analyze the natural language input data received, and the like. Further, a linguistic interface may be used to identify a particular language, dialect, or the like. In some examples, the linguistic interface may automatically determine the language, dialect, or the like. Additionally or alternatively, the system may request user input identifying a particular language, dialect, or the like.

At step 314, based on the processing performed at step 312 one or more outputs may be generated. For instance, an output may include generated response data generated in response to a determination of what the user was requesting. Additionally or alternatively, the output may include identification of a service or function to provide or execute for the user. In still other examples, the output may include identification of a decision tree to present various options to the user based on an identified request from the user. Various other outputs may be generated without departing from the invention.

At step 316, the output may be transmitted to the user, other entity systems, or the like. For instance, if the output includes a response to a user request, the response may be transmitted to the user (e.g., audio data may be presented to the user including the response). In another example, if the output includes identification of a decision tree, a step in the tree may be presented to the user (e.g., via audio data). In still another example, if the output includes a service or function to provide to the user, the service or function may be executed and confirmation may be provided to the user (e.g., a user request for an account balance may result in audio data presenting the account balance to the user).

At step 318, user response or feedback data may be received in response to transmitting the output. For instance, natural language input indicating selection of an option, user sign off or other utterance indicating satisfaction with the output, or the like, may be received from the user. At step 320, this user response data may be used as feedback to update and/or validate the one or more user-specific machine learning datasets in order to further improve accuracy and efficiency of the system.

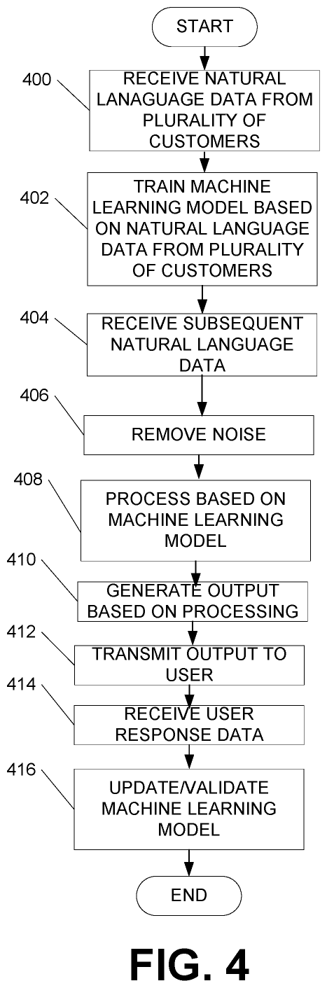

FIG. 4 is a flow chart illustrating another example method of implementing intelligent interactive voice recognition functions according to one or more aspects described herein. The processes illustrated in FIG. 4 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 4 may be performed in real-time or near real-time.

At step 400, natural language input may be received from a plurality of users of an interactive voice recognition system. In some examples, the users may be customers of an enterprise organization implementing the intelligent interactive voice recognition computing platform 110. In some examples, the natural language input may be received over a period of time and may include historical data.

At step 402, one or more machine learning models may be built and/or trained based on the natural language data received from the plurality of users. For instance, one or machine learning datasets may be generated. The plurality of users may include users speaking different languages or dialects, having atypical speech patterns (e.g., speech impediment), or the like. Generating the machine learning datasets based on a variety of spoken languages and speech patterns may provide improved understanding of the user during, for instance, other interactions with the intelligent interactive voice recognition computing platform, particularly for speakers having atypical speech patterns that might be difficult to interpret using conventional interactive voice recognition systems. The machine learning datasets may aid in accurately interpreting a request or predicting a request for any user, even users who have never accessed the system before. In some examples, one or more machine learning classifiers may be used to classify words, intent, or the like, of the user.

At step 404, subsequent natural language input data may be received from a user. For instance, the user may, via a user device such as remote user computing device 170, initiate a connection with the intelligent interactive voice recognition computing platform 110 (e.g., via internal entity computing system 120 or voice recognition system hosted thereon). The user may be a previous user of the system or a first-time user.

In some examples, receiving the subsequent natural language input data may include receiving user or device identifying information that may be used to identify the user and retrieve user data, such as user account data, user authentication data, and the like.

At step 406, one or more noise reduction processes may be performed on the natural language input data received. For instance, one or more filtering or other noise reduction processes may be executed to isolate the relevant voice data.

At step 408, the isolated (e.g., noise removed) natural language data may be processed using the one or more machine learning datasets generated and/or one or more processes described herein. For instance, the various processes described herein may be executed (e.g., using machine learning) to determine an intent of the customer, identify the request, analyze the natural language input data received, and the like. Further, a linguistic interface may be used to identify a particular language, dialect, or the like. In some examples, the linguistic interface may automatically determine the language, dialect, or the like. Additionally or alternatively, the system may request user input identifying a particular language, dialect, or the like.

At step 410, based on the processing performed at step 408, one or more outputs may be generated. For instance, an output may include generated response data generated in response to a determination of what the user was requesting. Additionally or alternatively, the output may include identification of a service or function to provide or execute for the user. In still other examples, the output may include identification of a decision tree to present various options to the user based on an identified request from the user. Various other outputs may be generated without departing from the invention.

At step 412, the output may be transmitted to the user, other entity systems, or the like. For instance, if the output includes a response to a user request, the response may be transmitted to the user (e.g., audio data may be presented to the user including the response). In another example, if the output includes identification of a decision tree, a step in the tree may be presented to the user (e.g., via audio data). In still another example, if the output includes a service or function to provide to the user, the service or function may be executed and confirmation may be provided to the user (e.g., a user request for an account balance may result in audio data presenting the account balance to the user).

At step 414, user response or feedback data may be received in response to transmitting the output. For instance, natural language input indicating selection of an option, user sign off or other utterance indicating satisfaction with the output, or the like, may be received from the user. At step 416, this user response data may be used as feedback to update and/or validate the one or more machine learning datasets in order to further improve accuracy and efficiency of the system.

Aspects discussed herein are directed to using machine learning to analyze natural language input data received, for instance, via an interactive voice recognition system, to accurately analyze and understand natural language data from a variety of speakers. For instance, by using machine learning models trained from a vast array of users, and/or by generating user-specific machine learning datasets, the system may accurately interpret natural language input data received from users having different speech patterns, atypical speech patterns, speaking various different languages, and the like.

In some examples, the system may be particularly suited to interpreting natural language input data received from speakers having atypical speech patterns, such as those having a speech impediment including, for instance, a stutter, lisp, or the like. Using historical data from a large number of users over a period of time enables training of a machine learning model that has data to evaluate many different languages, speech patterns, and the like.

Further, the use of user-specific machine learning datasets may enable improved understanding of users as speech patterns for a particular user may change. For instance, if a user develops a modified speech pattern or speaks a different dialect because they have moved to another geographic area, the system may continuously update the user-specific machine learning datasets based on each interaction with the user to change and modify interpretation of the user's speech as the user's speech changes and is modified.

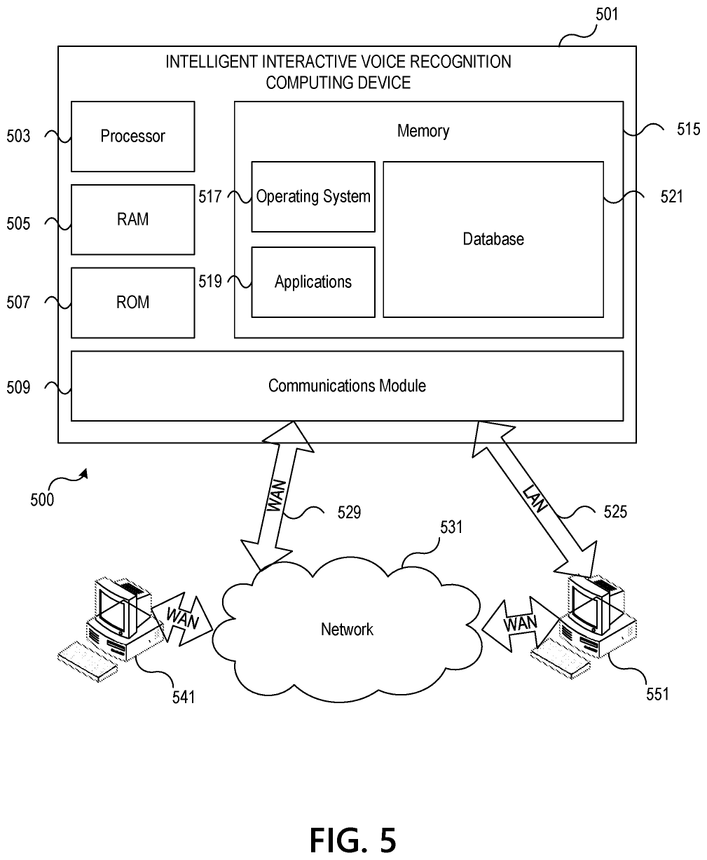

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include intelligent interactive voice recognition computing device 501 having processor 503 for controlling overall operation of intelligent interactive voice recognition computing device 501 and its associated components, including Random Access Memory (RAM) 505, Read-Only Memory (ROM) 507, communications module 509, and memory 515. Intelligent interactive voice recognition computing device 501 may include a variety of computer readable media. Computer readable media may be any available media that may be accessed by intelligent interactive voice recognition computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by intelligent interactive voice recognition computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on intelligent interactive voice recognition computing device 501. Such a processor may execute computer-executable instructions stored on a computer-readable medium.

Software may be stored within memory 515 and/or storage to provide instructions to processor 503 for enabling intelligent interactive voice recognition computing device 501 to perform various functions as discussed herein. For example, memory 515 may store software used by intelligent interactive voice recognition computing device 501, such as operating system 517, application programs 519, and associated database 521. Also, some or all of the computer executable instructions for intelligent interactive voice recognition computing device 501 may be embodied in hardware or firmware. Although not shown, RAM 505 may include one or more applications representing the application data stored in RAM 505 while intelligent interactive voice recognition computing device 501 is on and corresponding software applications (e.g., software tasks) are running on intelligent interactive voice recognition computing device 501.

Communications module 509 may include a microphone, keypad, touch screen, and/or stylus through which a user of intelligent interactive voice recognition computing device 501 may provide input, and may also include one or more of a speaker for providing audio output and a video display device for providing textual, audiovisual and/or graphical output. Computing system environment 500 may also include optical scanners (not shown).

Intelligent interactive voice recognition computing device 501 may operate in a networked environment supporting connections to one or more remote computing devices, such as computing devices 541 and 551. Computing devices 541 and 551 may be personal computing devices or servers that include any or all of the elements described above relative to intelligent interactive voice recognition computing device 501.

The network connections depicted in FIG. 5 may include Local Area Network (LAN) 525 and Wide Area Network (WAN) 529, as well as other networks. When used in a LAN networking environment, intelligent interactive voice recognition computing device 501 may be connected to LAN 525 through a network interface or adapter in communications module 509. When used in a WAN networking environment, intelligent interactive voice recognition computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

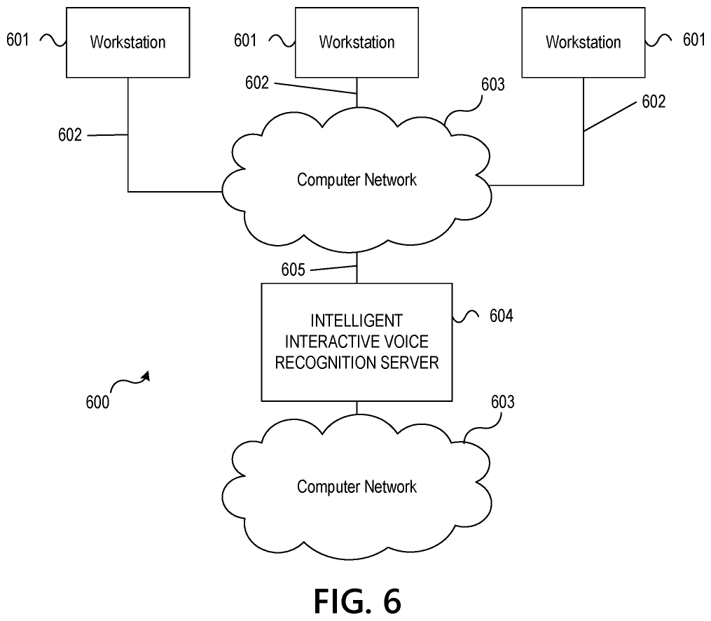

FIG. 6 depicts an illustrative block diagram of workstations and servers that may be used to implement the processes and functions of certain aspects of the present disclosure in accordance with one or more example embodiments. Referring to FIG. 6, illustrative system 600 may be used for implementing example embodiments according to the present disclosure. As illustrated, system 600 may include one or more workstation computers 601. Workstation 601 may be, for example, a desktop computer, a smartphone, a wireless device, a tablet computer, a laptop computer, and the like, configured to perform various processes described herein. Workstations 601 may be local or remote, and may be connected by one of communications links 602 to computer network 603 that is linked via communications link 605 to intelligent interactive voice recognition server 604. In system 600, intelligent interactive voice recognition server 604 may be a server, processor, computer, or data processing device, or combination of the same, configured to perform the functions and/or processes described herein. Server 604 may be used to receive natural language input data, build or train machine learning models, analyze natural language input data received using the one or more processes described herein, generate an output, receive user feedback, update and/or validate one or more machine learning datasets, and the like.

Computer network 603 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 602 and 605 may be communications links suitable for communicating between workstations 601 and intelligent interactive voice recognition server 604, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
train a machine learning model based on natural language data received via an interactive voice response (IVR) system, training the machine learning model including capturing and analyzing data from a plurality of users during a plurality of interactions of the plurality of users with the IVR system;
receive natural language data including a request from a first user;
process the natural language data to remove noise;
after removing the noise, further process the natural language data to process the request of the first user, further processing the natural language data including analyzing the natural language data using the machine learning model;
generate an output based on the further processing;
transmit the output to the user;
receive feedback data in response to the transmitted output; and
validate the machine learning model based on the received feedback data.

2. The computing platform of claim 1, wherein further processing the natural language data further includes executing a query analyzer based on recent history of calls, transactions and current status of the first user.

3. The computing platform of claim 2, wherein further processing the natural language data further includes executing a context detector to identify a correct sense of words in the request.

4. The computing platform of claim 3, wherein further processing the natural language data further includes executing an utterance detector to identify intended voice data and filter unintended voice data.

5. The computing platform of claim 4, wherein further processing the natural language data further includes executing an intent manager to calculate intent level statistics.

6. The computing platform of claim 5, wherein further processing the natural language data further includes executing intent prediction and voice coding processes to predict an intent of the first user in the natural language data.

7. The computing platform of claim 1, further including instructions that, when executed, cause the computing platform to:
execute one or more unauthorized activity detection processes based on the natural language data.

8. A method, comprising:
training, by a computing platform having a memory and at least one processor, a machine learning model based on natural language data received via an interactive voice response (IVR) system, training the machine learning model including capturing and analyzing data from a plurality of users during a plurality of interactions of the plurality of users with the IVR system;
receiving, by the at least one processor, natural language data including a request from a first user;
processing, by the at least one processor, the natural language data to remove noise;
after removing the noise, further processing, by the at least one processor, the natural language data to process the request of the first user, further processing the natural language data including analyzing the natural language data using the machine learning model;
generating, by the at least one processor, an output based on the further processing;
transmitting, by the at least one processor, the output to the user;
receiving, by the at least one processor, feedback data in response to the transmitted output; and
validating, by the at least one processor, the machine learning model based on the received feedback data.

9. The method of claim 8, wherein further processing the natural language data further includes executing a query analyzer based on recent history of calls, transactions and current status of the first user.

10. The method of claim 9, wherein further processing the natural language data further includes executing a context detector to identify a correct sense of words in the request.

11. The method of claim 10, wherein further processing the natural language data further includes executing an utterance detector to identify intended voice data and filter unintended voice data.

12. The method of claim 11, wherein further processing the natural language data further includes executing an intent manager to calculate intent level statistics.

13. The method of claim 12, wherein further processing the natural language data further includes executing intent prediction and voice coding processes to predict an intent of the first user in the natural language data.

14. The method of claim 8, further including:
executing, by the at least one processor, one or more unauthorized activity detection processes based on the natural language data.

15. One or more non-transitory computer-readable media storing instructions that, when executed by a computing platform associated with a first entity and comprising at least one processor, memory, and a communication interface, cause the computing platform to:
train a machine learning model based on natural language data received via an interactive voice response (IVR) system, training the machine learning model including capturing and analyzing data from a plurality of users during a plurality of interactions of the plurality of users with the IVR system;
receive natural language data including a request from a first user;
process the natural language data to remove noise;
after removing the noise, further process the natural language data to process the request of the first user, further processing the natural language data including analyzing the natural language data using the machine learning model;
generate an output based on the further processing;
transmit the output to the user;
receive feedback data in response to the transmitted output; and
validate the machine learning model based on the received feedback data.

16. The one or more non-transitory computer-readable media of claim 15, wherein further processing the natural language data further includes executing a query analyzer based on recent history of calls, transactions and current status of the first user.

17. The one or more non-transitory computer-readable media of claim 16, wherein further processing the natural language data further includes executing a context detector to identify a correct sense of words in the request.

18. The one or more non-transitory computer-readable media of claim 17, wherein further processing the natural language data further includes executing an utterance detector to identify intended voice data and filter unintended voice data.

19. The one or more non-transitory computer-readable media of claim 18, wherein further processing the natural language data further includes executing an intent manager to calculate intent level statistics.

20. The one or more non-transitory computer-readable media of claim 19, wherein further processing the natural language data further includes executing intent prediction and voice coding processes to predict an intent of the first user in the natural language data.

21. The one or more non-transitory computer-readable media of claim 15, further including instructions that, when executed, cause the computing platform to:
execute one or more unauthorized activity detection processes based on the natural language data.
